(19) United States
(12) Patent Application Publication
(10) Pub. No.: US 2016/0059790 A1
(43) Pub. Date: Mar. 3, 2016

(54) Vehicle Floor Mat Having Collapsible Storage Container

(71) Applicant: KRACO ENTERPRISES, LLC., Compton, CA (US)

(72) Inventors: Thomas Perelli, Raleigh, NC (US); Kenneth A. Gross, Northridge, CA (US); John J. Fiumefreddo, Huntington Beach, CA (US)

(21) Appl. No.: 14/839,269

(22) Filed: Aug. 28, 2015

Related U.S. Application Data
(60) Provisional application No. 62/043,829, filed on Aug. 29, 2014.

(51) Int. Cl. B60R 7/04; B65D 25/04; B65D 43/02; B65D 21/08

(52) U.S. Cl. CPC B60R 7/04; B65D 21/086; B65D 25/04; B65D 43/02

(57) ABSTRACT

A floor mat for use in a vehicle includes a main body and a collapsible storage container operatively coupled with the main body and having at least one wall. The collapsible storage container is selectively movable between a collapsed position in which the at least one wall lies substantially parallel to the main body and an erected position in which the at least one wall projects outwardly from the main body to define a storage area. Another floor mat for use in a vehicle includes a main body, a first collapsible storage container operatively coupled with the main body, and at least one second collapsible storage container operatively coupled with the main body. The first and second collapsible storage containers are each selectively movable between a collapsed position and an erected position in which the first and second containers define first and second independent storage areas.

### CROSS-REFERENCE TO RELATED APPLICATION

This application claims the priority of U.S. Provisional Application Ser. No. 62/043,829, filed Aug. 29, 2014, the disclosure of which is hereby incorporated by reference herein.

### TECHNICAL FIELD

The present invention relates generally to floor mats for use in vehicles, and more particularly, to storage of articles within a vehicle.

### BACKGROUND

Floor mats are generally configured to overlie and thereby protect a floor of a vehicle. In this regard, floor mats may be sized to protect a portion of the vehicle floor in a particular region of the vehicle. For example, floor mats for protecting a floor portion in a cargo region of the vehicle may be large, while floor mats for protecting a floor portion in a passenger region of the vehicle may be smaller. Aftermarket floor mats are available and often times may be customized with various dimensions to fit vehicles of various types. For example, aftermarket floor mats may include one or more trimmable areas which may be trimmed by a user to provide the floor mat with proper dimensions generally corresponding to a floor portion of a particular vehicle.

Vehicles are often used for transporting various types of non-passenger articles, such as groceries, equipment, or personal items. Furthermore, storing and securing the articles during movement of the vehicle is generally desirable. Unrestrained articles may shift during vehicle movement, which may disadvantageously distract the driver or even cause damage to the articles. Known floor mats are often positioned in regions of the vehicle, such as the cargo region, where such articles are commonly placed for transport. However, current floor mats are deficient in providing structure that is adequate for storing and securing articles during vehicle movement. Accordingly, known vehicle floor mats may be improved upon.

### SUMMARY

In one embodiment, a floor mat for use in a vehicle comprises a main body and a collapsible storage container operatively coupled with the main body and including at least one wall. The collapsible storage container is selectively movable between a collapsed position in which the at least one wall lies substantially parallel to the main body, and an erected position in which the at least one wall projects outwardly from the main body to define a storage area.

In another embodiment, a floor mat for use in a vehicle includes a main body, a first collapsible storage container operatively coupled with the main body and including at least one wall, and at least one second collapsible storage container operatively coupled with the main body and including at least one wall. The first collapsible storage container is selectively movable between a collapsed position in which the at least one wall lies substantially parallel to the main body, and an erected position in which the at least one wall projects outwardly from the main body to define a first storage area. Similarly, the second collapsible storage container is selectively movable between a collapsed position in which the at least one wall lies substantially parallel to the main body, and an erected position in which the at least one wall projects outwardly from the main body to define a second storage area independent from the first storage area.

In another embodiment, a method of storing articles in a vehicle using a floor mat is provided. The floor mat includes a main body and a collapsible storage container operatively coupled with the main body and having at least one wall. The method includes lifting an edge of the at least one wall to move the collapsible storage container from a collapsed position toward an erected position. The method further includes releasably locking the collapsible storage container in the erected position so that the at least one wall projects outwardly from the main body and defines a storage area.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

FIG. 1 is a perspective view of an exemplary embodiment of a vehicle floor mat having a collapsible storage container in accordance with the principles of the invention.

FIG. 2 is an enlarged perspective view of the floor mat of FIG. 1, showing the collapsible storage container in a collapsed position.

FIG. 3 is a perspective view of the floor mat of FIG. 1, showing a first step in erecting the collapsible storage container from the collapsed position toward an erected position.

FIG. 4 is a perspective view of the floor mat of FIG. 1, showing a second step in erecting the collapsible storage container toward the erected position.

FIG. 5 is a perspective view of the floor mat of FIG. 1, showing the collapsible storage container in the erected position.

FIG. 6 is a perspective similar to FIG. 5, showing the erected collapsible storage container with selectively adjustable dividers.

FIG. 7 is a perspective view of the floor mat of FIG. 1, showing a first step in collapsing the collapsible storage container from the erected position toward the collapsed position.

FIG. 8 is a perspective view of a second exemplary embodiment of a vehicle floor mat having multiple collapsible storage containers in accordance with the principles of the invention.

FIG. 9 is a perspective view of a third exemplary embodiment of a vehicle floor mat in accordance with the principles of the invention in which the collapsible storage container includes a lid.

FIG. 10 is a perspective view of a fourth exemplary embodiment of a vehicle floor mat in accordance with the principles of the invention in which first and second collapsible storage containers are provided on first and second portions of the floor mat.

FIG. 11 is a perspective view of the vehicle floor mat of FIG. 10, showing the first collapsible storage container in an erected position.

FIG. 12 is a perspective view of a fifth exemplary embodiment of a vehicle floor mat in accordance with the principles of the invention, similar to the vehicle floor mat of FIG. 10 but including first and second collapsible shelves and a third collapsible storage container on a medial portion of the floor mat.

FIG. 13 is a perspective view of the vehicle floor mat of FIG. 12, showing the collapsible shelves in erected positions.

FIG. 14 is a perspective view of the vehicle floor mat of FIG. 13, showing the third collapsible storage container in an erected position.

### DETAILED DESCRIPTION

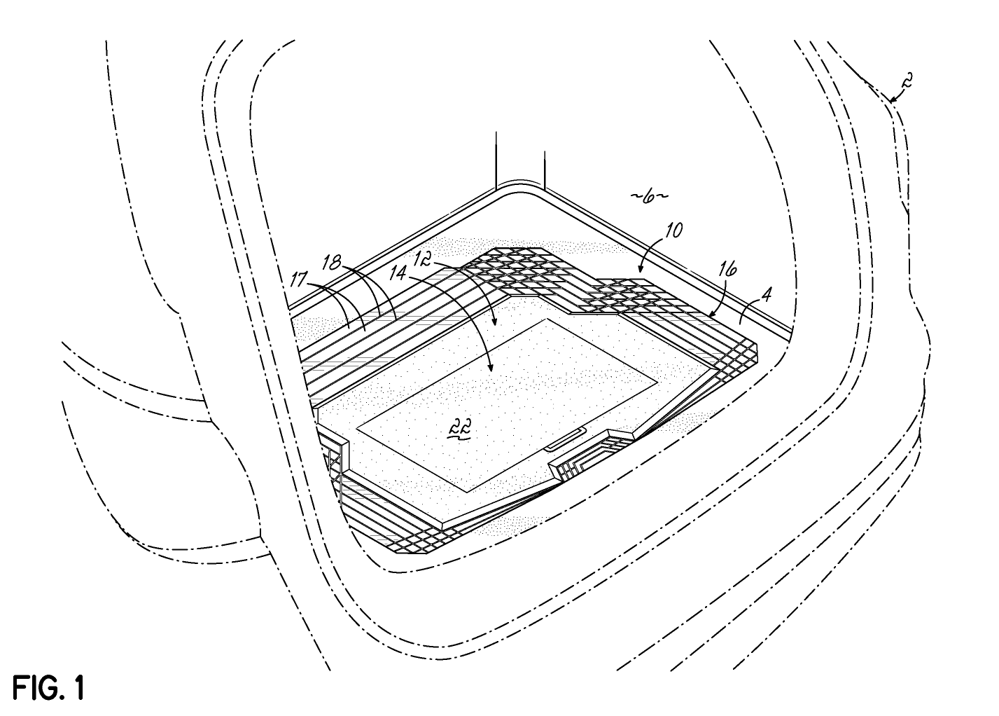

Referring to FIG. 1, a first exemplary embodiment of a floor mat 10 for use in a vehicle 2 is shown. The floor mat 10 is shown in the form of a cargo mat configured to cover and thereby protect a portion of a vehicle floor 4 located in a cargo region 6 of the vehicle 2. Persons skilled in the art will appreciate that the floor mat 10 may be formed with any suitable size and shape for use in other regions of the vehicle 2 as well, such as in a passenger region adjacent to one or more passenger seats.

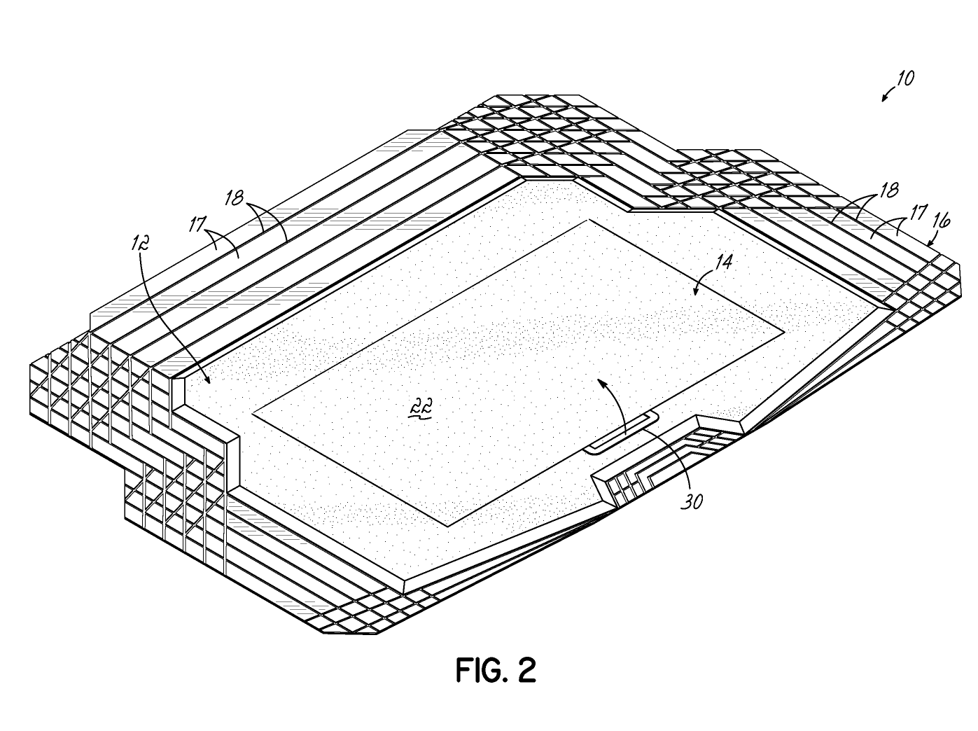

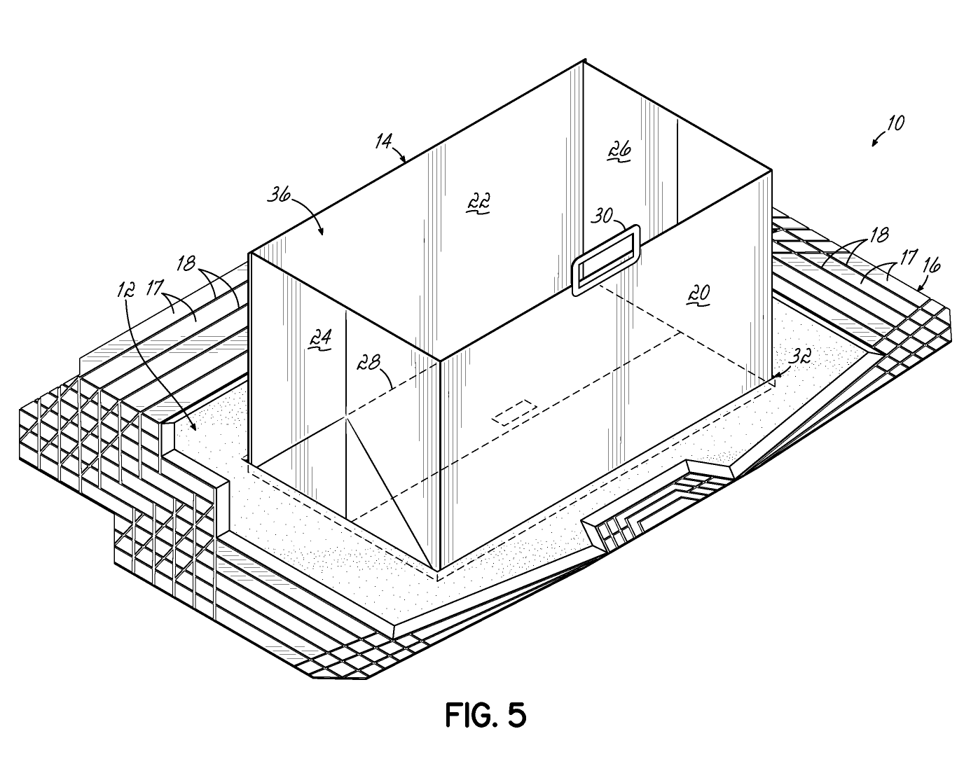

The floor mat 10 includes a main body 12 and a collapsible storage container 14 operatively coupled with the main body 12. As described in greater detail below, the collapsible storage container 14 is selectively movable between a collapsed position, shown in FIGS. 1 and 2, and an erected position, shown in FIG. 5. The main body 12 of the floor mat 10 may be formed of a plastic or a rubber resin, for example. Additionally, the main body 12 may include a laterally extending peripheral portion 16 having a plurality of trimmable portions 17 defined by a plurality of grooves 18. The trimmable portions 17 may be selectively trimmed by a user along one or more of the grooves 18 to provide the floor mat 10 with dimensions as desired to allow for a proper fit of the floor mat 10 into a particular vehicle.

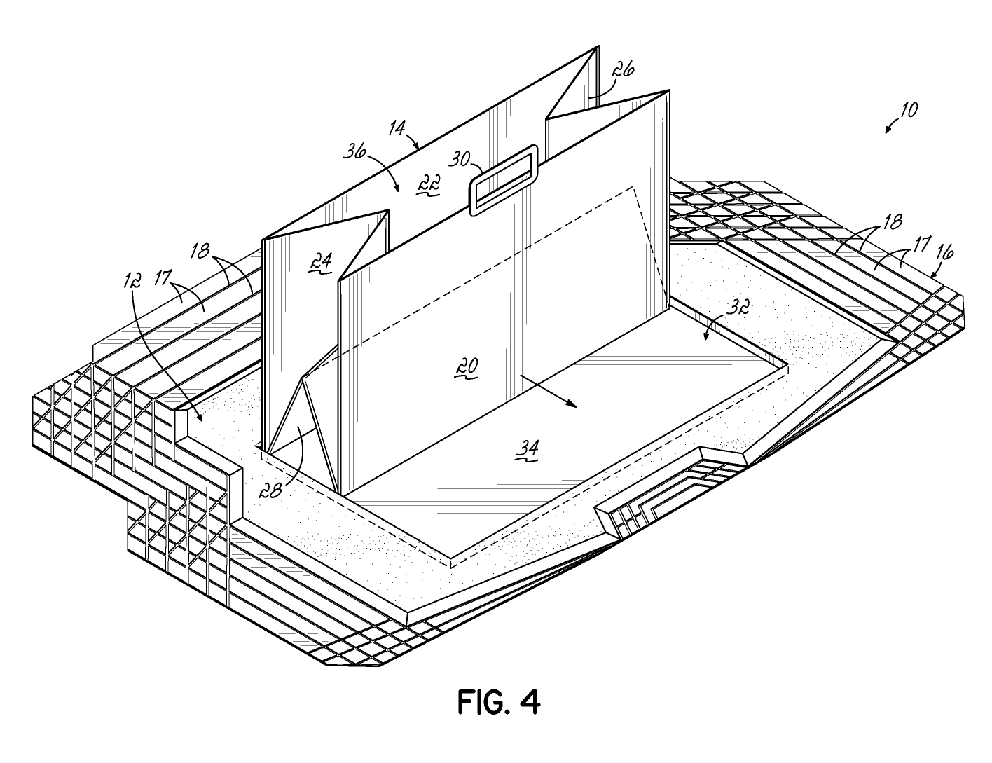

As best shown in FIGS. 4 and 5, the collapsible container 14 may include a plurality of hingedly connected, collapsible walls, including a front wall 20, a back wall 22, a first side wall 24, and a second side wall 26. Additionally, in one embodiment, the container 14 may include a bottom wall 28 having two hingedly connected collapsible portions. As shown in FIG. 5, each of the first and second sidewalls 24, 26 may include a plurality of hingedly connected collapsible portions that enable each of the side walls 24, 26 to fully collapse into the collapsed position, while remaining hingedly connected to the front wall 20, the back wall 22, and the bottom wall 28. Persons skilled in the art will appreciate that in alternative embodiments, the side walls 24, 26 may be hingedly connected to the front wall 20 and to the back wall 22, but not to the bottom wall 28.

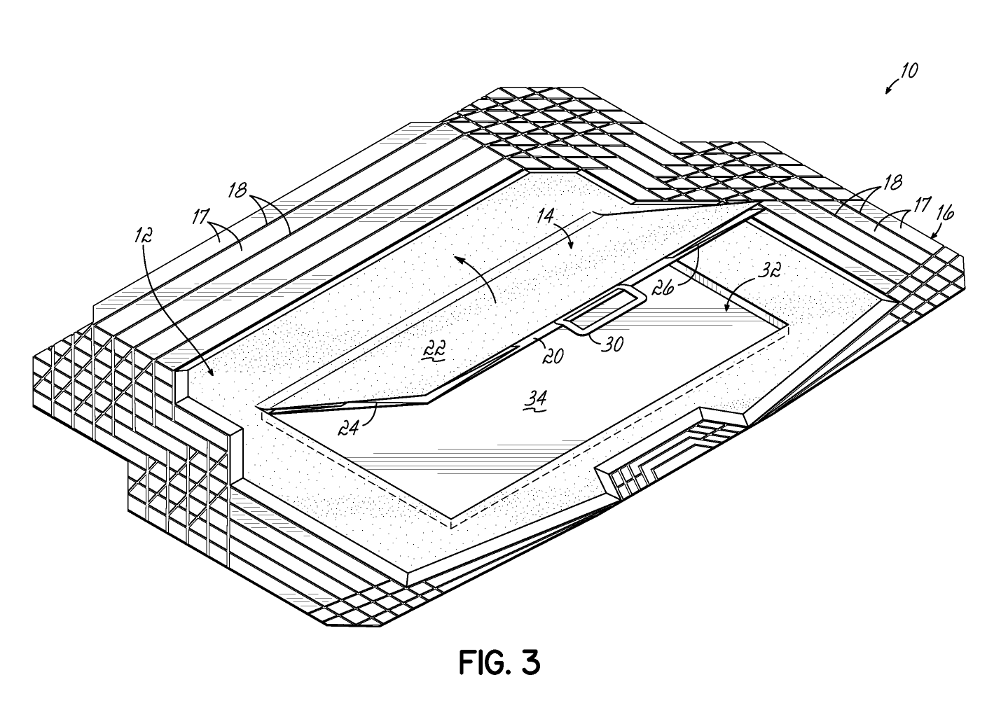

Referring back to FIGS. 2 and 3, the collapsible storage container 14 may include a handle 30 for aiding a user in erecting the container 14 from the collapsed position toward the erected position, for example to a partially erected position, shown in FIG. 4. A pulling force may be exerted on the handle 30 to lift the collapsed container 14 from a cavity 32 in which the container 14 is stowed and concealed when in the collapsed position. The cavity 32 is defined by the main body 12 and is preferably sized and shaped to conform to the size and shape of the container 14 when in the collapsed position. For example, as shown in FIG. 3, the cavity 32 may be generally rectangular and have a depth that allows the back wall 22 of the container 14 to lie substantially flush with, or at least parallel to, the main body 12 of the floor mat 10 when in the collapsed position. The cavity 32 is bounded by a bottom surface 34 that supports the container 14 when in the collapsed position, the erected position, and/or any intermediate position therebetween. In one embodiment, the cavity 32 may extend only partially through a thickness of the floor mat 10 such that the bottom surface 34 is defined by the main body 12 of the floor mat 10. In another embodiment, the cavity 32 may extend fully through the thickness of the floor mat 10 such that the bottom surface 34 is defined by the vehicle floor 4.

As best shown in FIG. 3, the back wall 22 of the container 14 may be hingedly connected to the main body 12 of the floor mat 10 such that a bottom edge of the back wall 22 defines an axis about which the container 14 may pivot when being moved between the collapsed position and the erected position. The hinged connection of the back wall 22 of the container 14 to the main body 12 of the floor mat 10 may be formed by a piece of fabric, such as carpet, or by any other suitable hinging mechanism. In one embodiment, a top surface of the main body 12 and an outwardly facing surface of the back wall 22 may each be provided with sections of carpet or other fabric, for example, which are sized to cover the corresponding main body 12 and back wall 22. In this manner, when the container 14 is in the collapsed position and fully seated within the cavity 32, the container 14 is concealed from view and a substantially uniform and flush outer surface is provided, for example for placement of articles.

FIG. 4 shows the container 14 in a partially erected position in which at least the front wall 20 and the back wall 22 are positioned substantially vertically relative to the bottom surface 34 of the cavity 32. The front wall 20 may be moved in a direction away from the back wall 22. Simultaneously, the collapsible portions of the side walls 24, 26 may be moved outwardly, and the collapsible portions of the bottom wall 28 may be moved downwardly. Thereby, the container 14 may be fully opened and releasably locked into the erected position, shown in FIG. 5.

As shown in FIG. 5, the container 14 is provided in a fully erected position in which the front wall 20, the back wall 22, and the side walls 24, 26 collectively define a storage area 36 in which articles may be placed and secured. The erected walls 20, 22, 24, 26, 28 may exert mutual forces on each other to maintain the container 14 in the erected position. For example, the collapsible portions of the bottom wall 28 may be placed by a user into a releasably locked, erected position in which they exert outwardly directed compressive forces on the front wall 20 and the back wall 22. In turn, the front and back walls 20, 22 may exert outwardly directly tensile forces on the collapsible portions of the side walls 24, 26, thereby releasably locking the side walls 24, 26 in the erected position. In other embodiments, one or more of the walls 20, 22, 24, 26, 28 may be provided with support mechanisms (not shown) for maintaining the container 14 in the erected position.

The erected container 14 may remain seated within the cavity 32 of the floor mat 10, or alternatively the erected container 14 may be disconnected from, and later reconnected to, the floor mat 10 for use independent from the floor mat 10. In this regard, the container 14 may include one or more fasteners for releasably connecting the container 14 to the main body 12 of the floor mat 10. For example, the hinged connection between the back wall 22 and the main body 12 may be a releasable connection. In other embodiments, the container 14 may be releasably connected to the main body 12 with one or more snaps, zippers, hook and loop fasteners, or any other suitable fasteners.

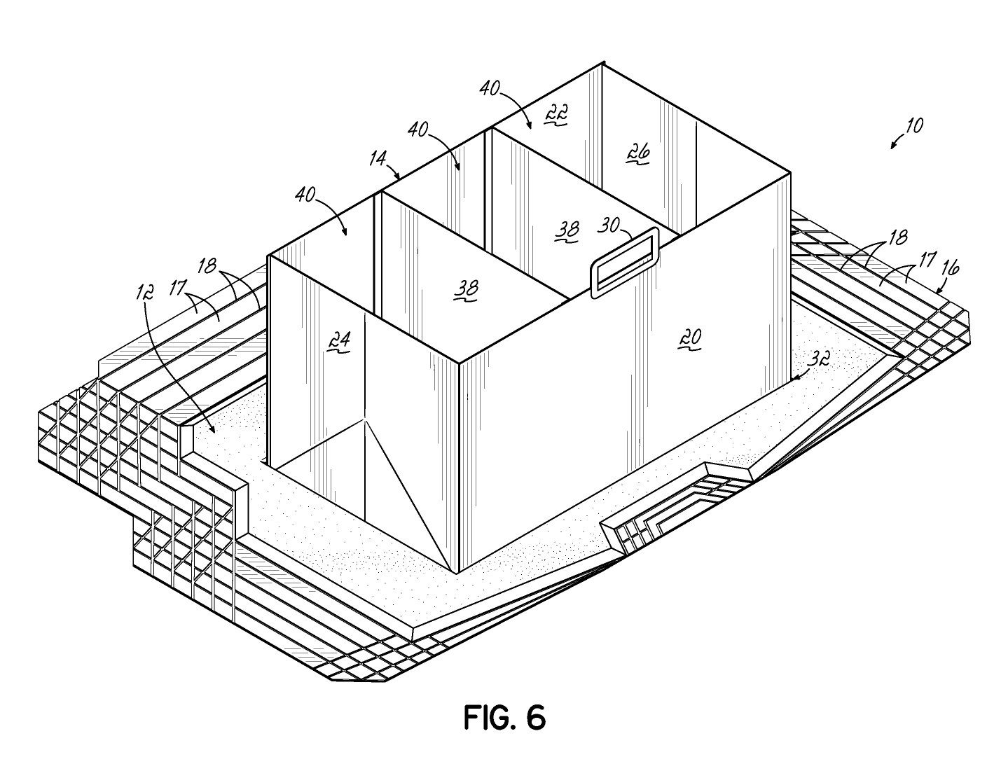

As shown in FIG. 6, the container 14 may additionally include one or more vertically-oriented dividers 38 for subdividing the storage area 36 into a plurality of smaller storage areas 40. One or more of the dividers 38 may be selectively positionably adjustable relative to the container 14 so that the smaller storage areas 40 may be varied in size. In one embodiment, the dividers 38 may be hingedly connected to the front wall 20 or the back wall 22 of the container 14, for example, so that they may collapse along with the walls 20, 22, 24, 26, 28 of the container 14 and be stowed in the cavity 32 in the collapsed position. In another embodiment, the dividers 38 may be releasably connected to the container 14, such as by snaps, zippers, hook and loop fasteners, or any other suitable structure, so that the dividers 38 may be removed before collapsing the container 14.

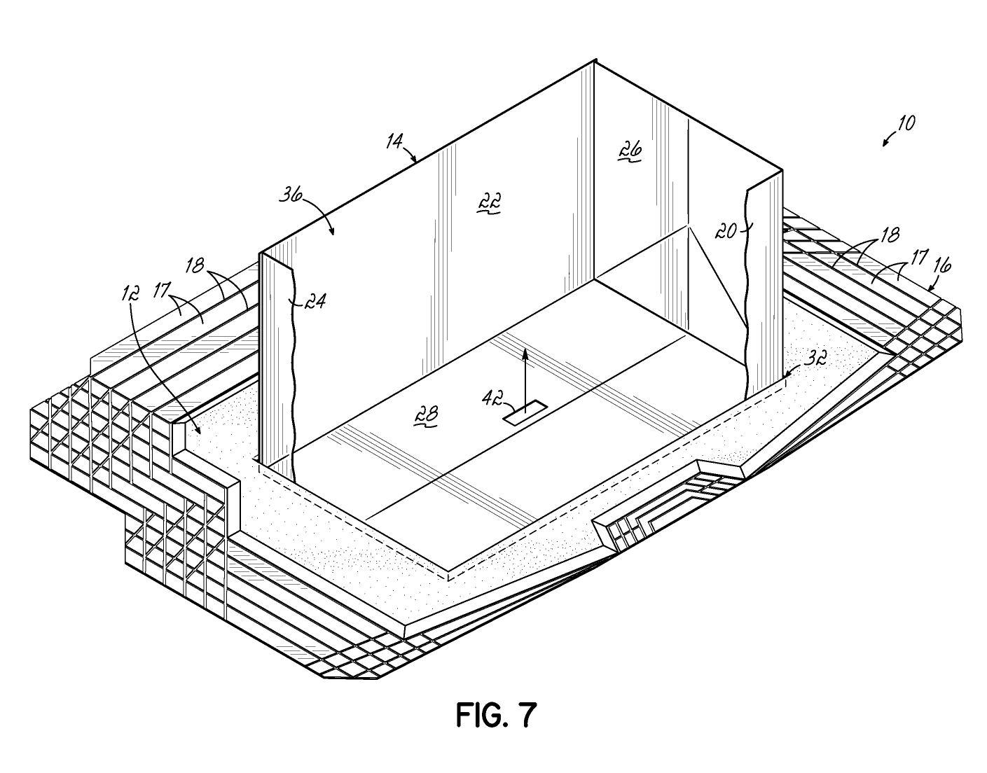

As shown in FIG. 7, the erected container 14 may be collapsed from the erected position back toward the collapsed position. In one embodiment, one or both of the collapsible portions of the bottom wall 28 may include an aperture 42 through which a user may insert a hand or finger to apply an upwardly directed force to collapse the bottom wall 28 at the hinged connection formed between the collapsible portions of the bottom wall 28. Simultaneously, the user may exert an inwardly directed force on each of the side walls 24, 26, for example at the hinged connections of their collapsible portions, to collapse the container 14 into a partially collapsed position similar to the partially erected position shown in FIG. 4. In this manner, the steps described above for erecting the container 14 may be generally reversed for collapsing the container 14 into the collapsed position in which the container 14 is stowed in the cavity 32 of the floor mat 10.

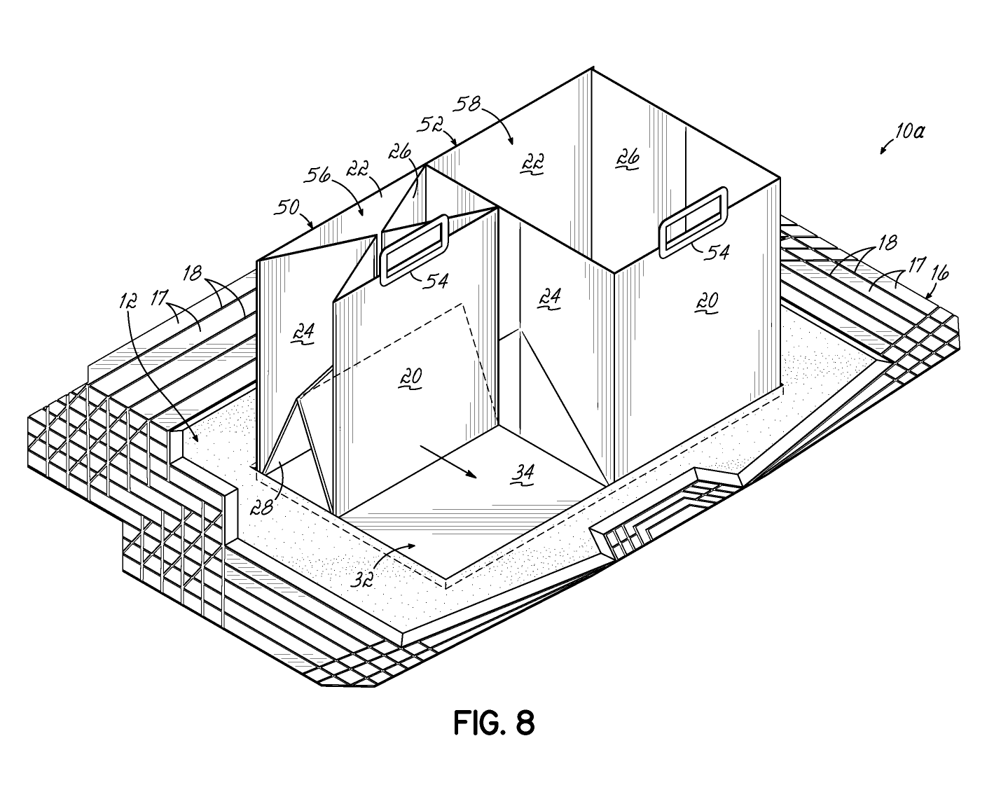

Referring to FIG. 8, a second exemplary embodiment of a vehicle floor mat in accordance with the principles of the invention is shown, for which similar reference numerals refer to similar features shown in FIGS. 1-7. In this embodiment, a vehicle floor mat 10a may include a plurality of independently collapsible storage containers operatively coupled with the main body 12. For example, as shown, the floor mat 10a may include a first collapsible storage container 50 and a second collapsible storage container 52. While only two containers are shown in this embodiment, persons skilled in the art will appreciate that alternative embodiments may include any number of collapsible storage containers, and that the various containers may be formed with various shapes and sizes, including internal volumes of the respective storage areas.

Each of the first and second containers 50, 52 shown may be provided with a handle 54 for erecting and collapsing the containers 50, 52 between a collapsed position and an erected position in a manner similar to that described above with respect to FIGS. 2-7. In this manner, in the erected position, the first container 50 may define a first storage area 56 and the second container 52 may define a second storage area 58 independent from the first storage area 56. Additionally, either or both of the first and second containers 50, 52 may be releasably connected to the main body 12 of the floor mat 10, as similarly described above, such that either or both of the containers 50, 52 may be selectively disconnected from, and later reconnected to, the main body 12 for use independent from the floor mat 10a.

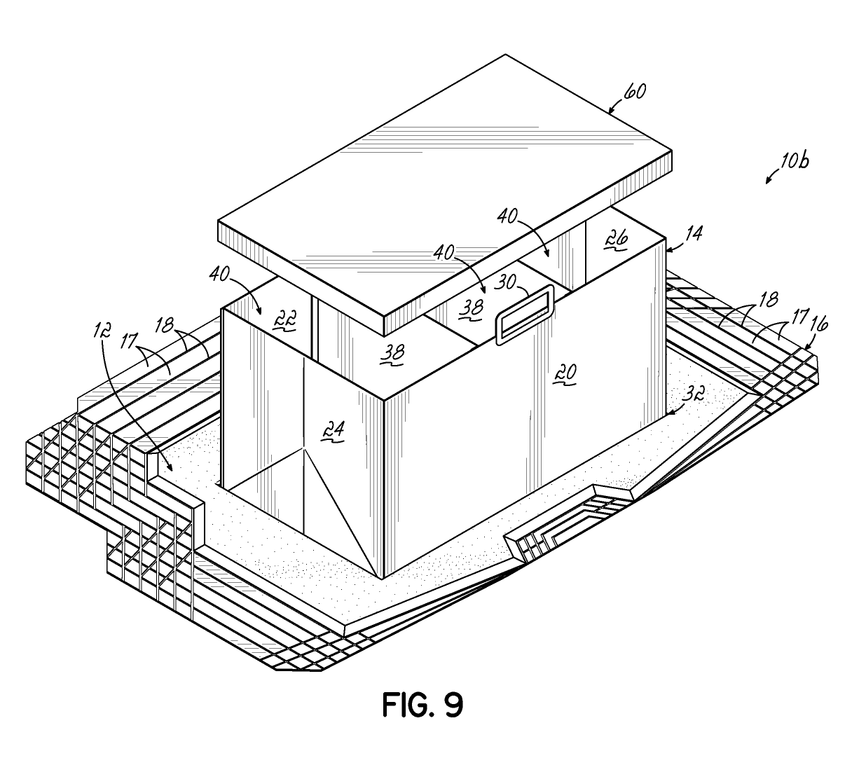

Referring to FIG. 9, a third exemplary embodiment of a vehicle floor mat in accordance with the principles of the invention is shown in the form of vehicle floor mat 10b, for which similar reference numerals refer to similar features shown in FIGS. 1-7. In this embodiment, floor mat 10b may be provided with a lid 60 for covering the storage area 36 defined by the collapsible storage container 14 in an erected position. The lid 60 may be releasably connected to the container 14, such as with one or more snaps, zippers, or any other suitable fasteners. Persons skilled in the art will appreciate that various other embodiments of the invention, such as those shown and described herein, may be provided with a lid as well.

Furthermore, various embodiments of collapsible storage containers in accordance with the principles of the invention may include sections and/or lids that are formed with an insulating material for substantially maintaining a temperature within the storage area, for example when the lid is positioned to cover the storage area. In this manner, collapsible storage containers in accordance with the principles of the invention may be used to store temperature-sensitive articles, such as foods, beverages, or ice, for example. Furthermore, various embodiments of collapsible storage containers and/or their corresponding lids in accordance with the principles of the invention may be may be formed with a liquid-resistant or a liquid-proof material. In this manner, the collapsible storage containers may be resistant to food and beverage spills, and various weather conditions, for example.

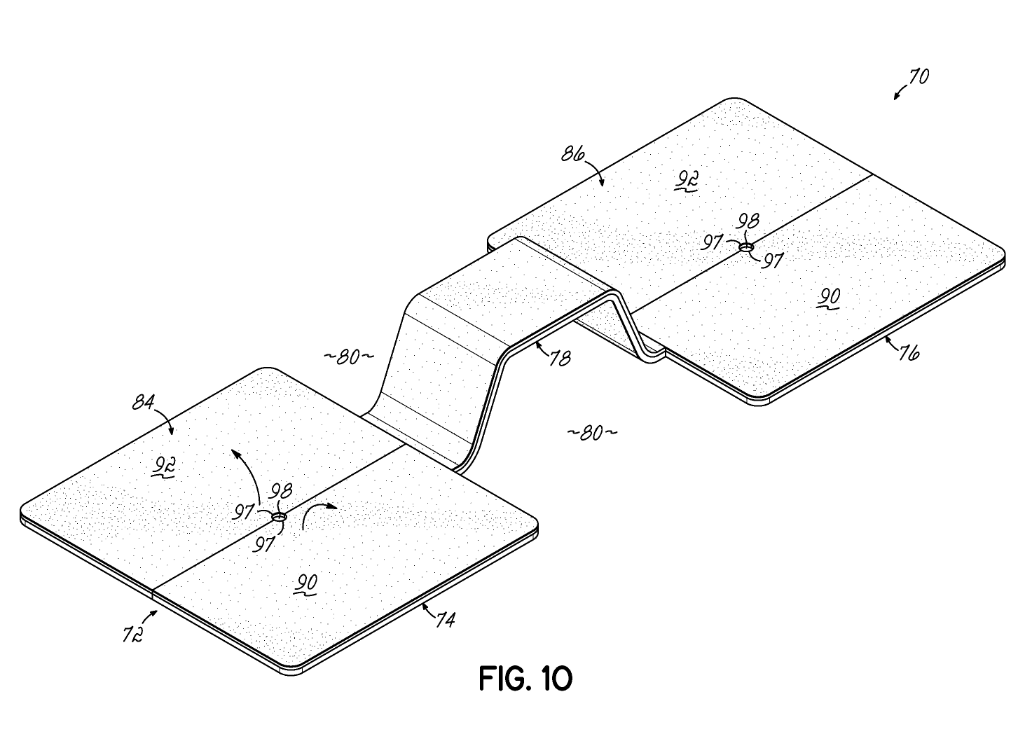

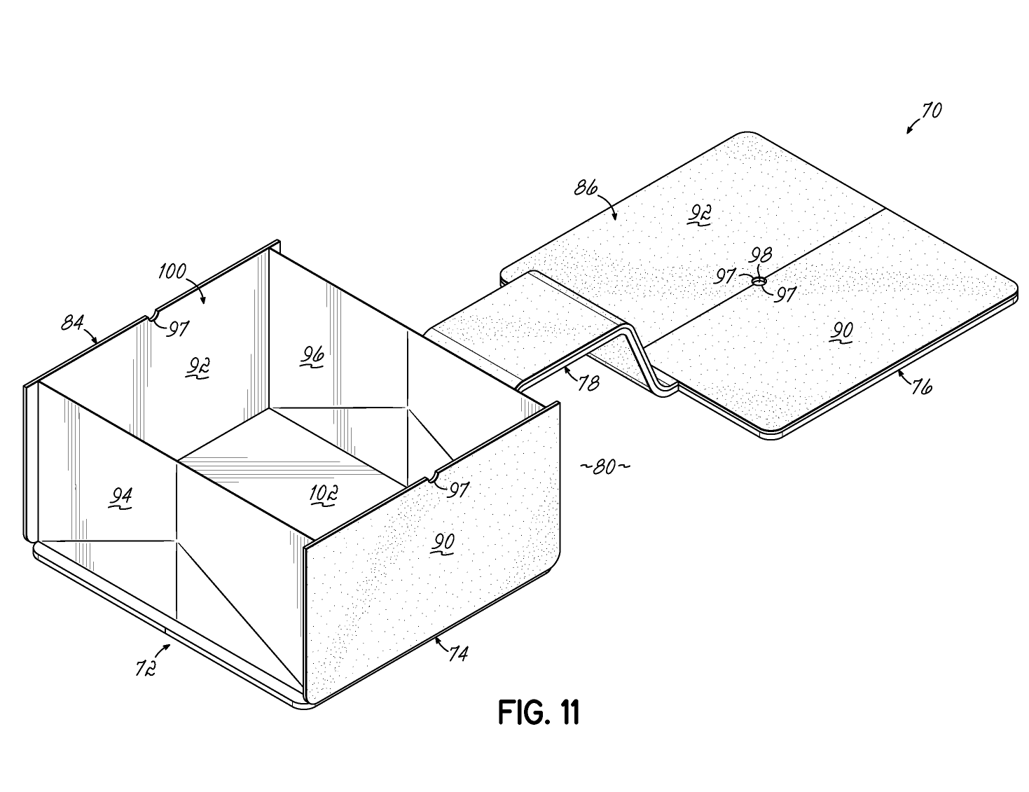

Referring to FIGS. 10 and 11, a fourth exemplary embodiment of a vehicle floor mat in accordance with the principles of the invention is shown in the form of a vehicle floor mat 70, which may be used in a passenger region (not shown) of the vehicle 2, such as a region located adjacent to and forward of a row of passenger seats, for example. The floor mat 70 includes a main body 72 having a first portion 74, a second portion 76, and a medial portion 78 connecting the first portion 74 and the second portion 76. As shown, the medial portion 78 may be formed with a width that is narrower than a width of the first portion 74 and a width of the second portion 76. The narrower width of the medial portion 78 may define one or more spaces 80 adjacent to the medial portion 78 and in between the first portion 74 and the second portion 76. The spaces 80 may be sized and shaped to accommodate adjacent structure in the vehicle 2, such as a center console (not shown). Additionally, as shown, the medial portion 78 may be formed with a flexible material to accommodate and generally conform to a raised surface defined by the vehicle floor 4, such as a raised surface (or “hump”) overlying a drive train of the vehicle 2.

The first portion 74 of the main body 72 may support a first collapsible storage container 84 and the second portion 76 may support a second collapsible storage container 86, the containers 84, 86 each being operatively coupled with their respective portions 74, 76 of the main body 72. Similar to the embodiments described above, each of the first and second containers 84, 86 are selectively movable between a collapsed position, shown in FIG. 10, and an erected position, shown in FIG. 11. In the embodiment shown, each of the first and second containers 84, 86 may be formed with a front wall 90, a back wall 92, a first side wall 94, and a second side wall 96. Each of the sidewalls 94, 96 may include a plurality of hingedly connected, collapsible portions that function in a manner similar to that described above for the collapsible portions of sidewalls 24, 26 of container 14, shown in FIGS. 1-7.

Referring to both the first collapsible storage container 84 and the second collapsible storage container 86, the front wall 90 and the back wall 92 may lie substantially parallel to the corresponding portion 74, 76 of the main body 72 when in the collapsed position. As shown, the front and back walls 90, 92 may include notches 97 that define an aperture 98 through which a user may insert one or more fingers for gripping the front and back walls 90, 92 and pivoting the walls 90, 92 outwardly to place the container 84, 86 into the erected position. The front and back walls 90, 92 may each be hingedly connected to the main body 72 such that a bottom edge of each of the front and back walls 90, 92 defines an axis about which the wall 90, 92 pivots for opening into the erected position. The sidewalls 94, 96 may be forced outwardly into a releasably locked position, in a manner similar to that described above for sidewalls 24, 26 shown in FIGS. 1-7. Thereby, the container 84, 86 may be secured and retained in the erected position, shown in FIG. 11.

As demonstrated by the first collapsible storage container 84 in FIG. 11, and similarly applicable to the second collapsible storage container 86, the erected container 84 defines a storage area 100 for storing articles. The storage area 100 is bounded by a bottom surface 102 that may be defined by the main body 72 of the floor mat 70. Additionally, outwardly facing surfaces of the front and back walls 90, 92 of each of the first and second collapsible containers 84, 86, as well as the medial portion 78 of the main body 72, may be lined with a fabric, such as carpet. Accordingly, when in the collapsed position, each of the containers 84, 86 may provide a surface that is comfortable for the feet of passengers seated adjacent to the floor mat 70.

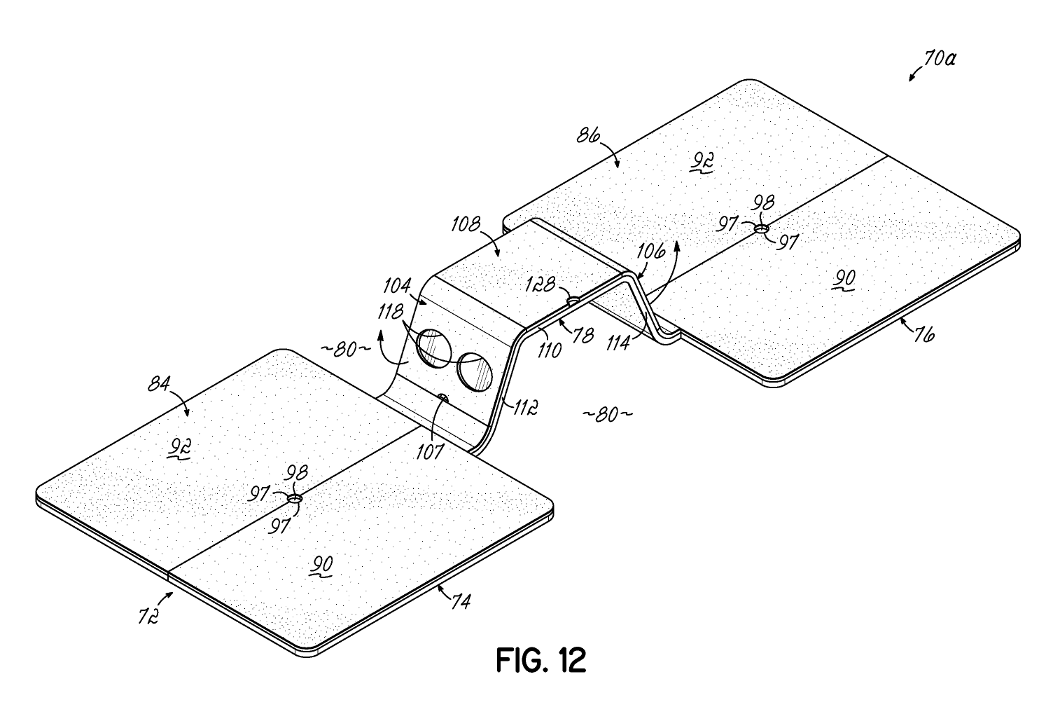

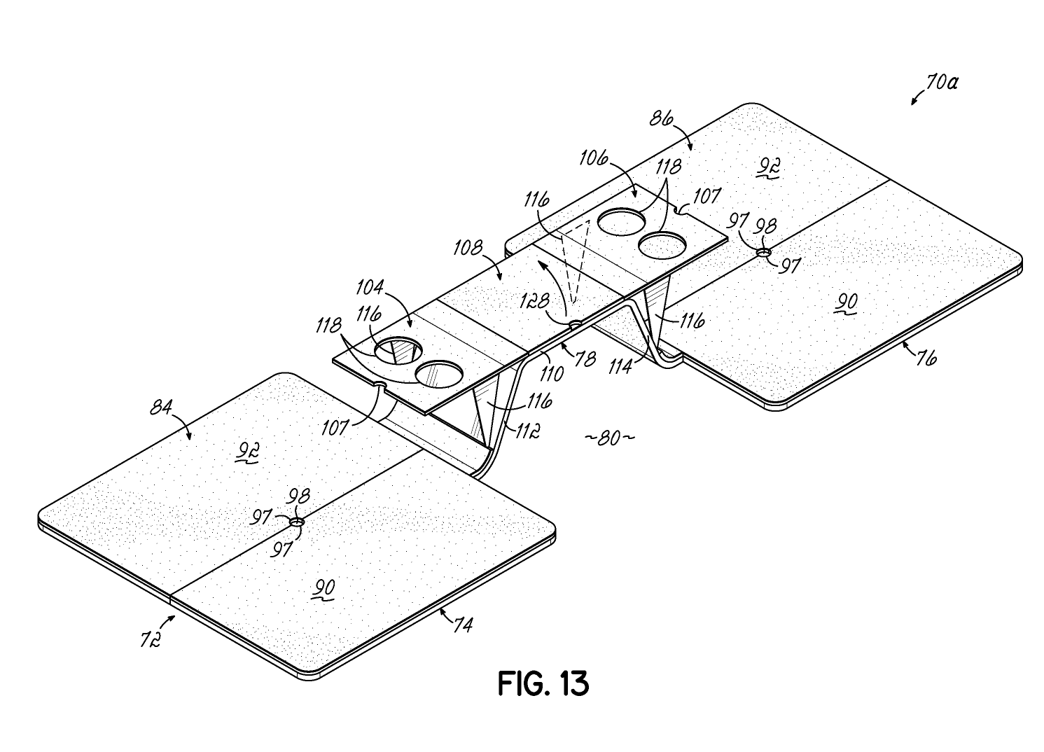

Referring to FIGS. 12-14, a fifth exemplary embodiment of a vehicle floor mat in accordance with the principles of the invention is shown in the form of vehicle floor mat 70a, for which similar reference numerals refer to similar features shown in FIGS. 10 and 11. In this embodiment, the medial portion 78 of the main body 72 of the may include one or more collapsible shelves, such as shelves 104, 106, and a third collapsible storage container 108. As shown, the third container 108 may be supported on a central section 110 of the medial portion 78, with the shelves 104, 106 provided on opposed side sections 112, 114 of the medial portion 78. Each shelf 104, 106 may be selectively movable between a collapsed position, shown in FIG. 12, and an erected position, shown in FIG. 13.

Expansion of the shelves 104, 106 into the erected position may generally depend on the medial portion 78 being shaped into a convex form, such as that shown in FIG. 12, such that the shelves 104, 106 are positioned vertically or at least angularly relative to a horizontal plane when in the collapsed position. The convex form may be provided by positioning the floor mat 70a within a region of the vehicle 2 such that the medial portion 78 is draped over a raised surface of the vehicle floor 4. Alternatively, the medial portion 78 may be formed with a rigid or semi-rigid material that provides such a convex shape.

Each shelf 104, 106 may be hingedly connected at an inner edge to the medial portion 78 such that the shelf 104, 106 may be pivoted from the collapsed position into the erected position using a notch 107 provided at an outer edge of the shelf 104, 106. Furthermore, as shown in FIG. 13, each shelf 104, 106 may include one or more support flaps 116, which may be hingedly connected to the shelf 104, 106, and which may be folded outwardly to contact the medial portion 78 of the floor mat 70a. Thereby, the shelves 104, 106 may be supported and maintained in an erected position. As shown, each shelf 104, 106 may include a plurality of apertures 118, which may be used for receiving and securing beverage containers, for example.

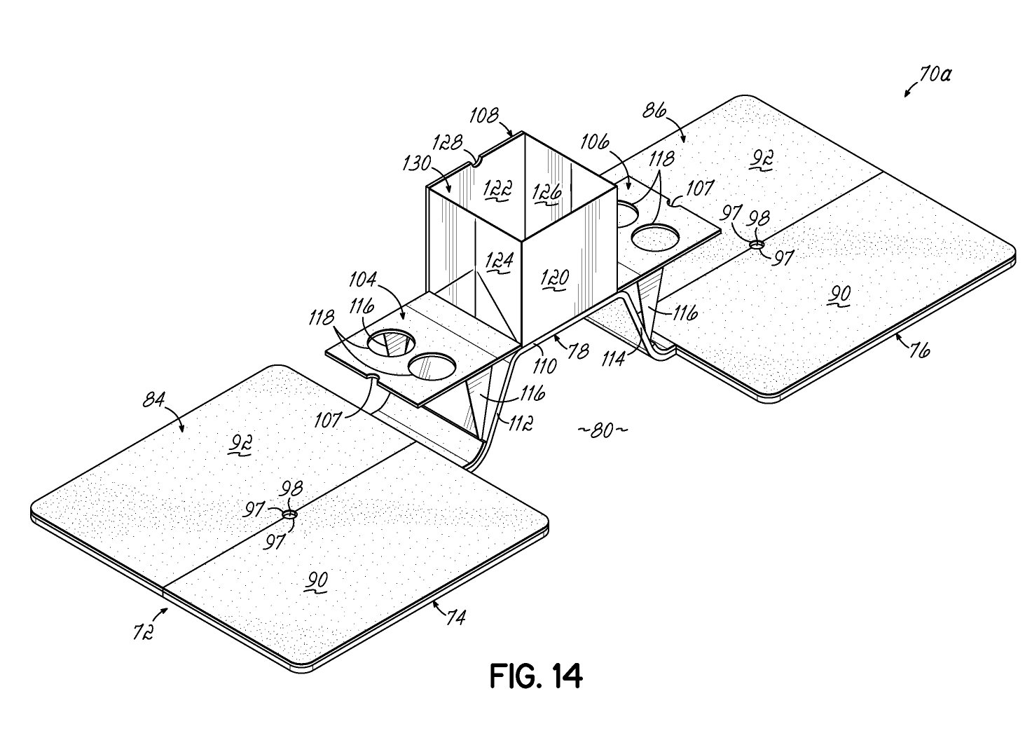

As shown in FIGS. 13 and 14, the third collapsible storage container 108 supported by the medial portion 78 of the floor mat 70a may include features similar to those of the container 14 shown in FIGS. 1-7, and may be erected and collapsed in a similar manner. In this regard, the third container 108 may include a front wall 120, a back wall 122, a first side wall 124, a second side wall 126, and optionally a bottom wall (not shown). The third container 108 is selectively movable between a collapsed position in which the back wall 122 may lie substantially parallel to central section 110 of the medial portion 78, and an erected position in which the walls 120, 122, 124, 126 extend outwardly to collectively define a storage area 130 for receiving and securing articles. The third container 108 may include a notch 128 provided at an outer edge, which may be gripped by a user for moving the container 108 between the collapsed and erected positions. Additionally, the third container 108 may be releasably connected to the medial portion 78 with one or more fasteners, such as those described above, such that the third container 108 may be disconnected from, and later reconnected to, the medial portion 78 for use independent from the floor mat 70a.

While various embodiments of collapsible storage containers in accordance with the principles are shown and described herein as having generally rectangular cross-sectional shapes, persons skilled in the art will appreciate that features of the invention may be modified as appropriate to provide collapsible storage containers having any other suitable shapes and sizes.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A floor mat for use in a vehicle, the floor mat comprising:
a main body; and
a collapsible storage container operatively coupled with the main body and including at least one wall, the collapsible storage container being selectively movable between a collapsed position in which the at least one wall lies substantially parallel to the main body, and an erected position in which the at least one wall projects outwardly from the main body to define a storage area.

2. The floor mat of claim 1, wherein the main body includes a cavity sized and shaped to receive the collapsible storage container therein in the collapsed position.

3. The floor mat of claim 1, wherein the collapsible storage container includes a front wall, a back wall, a first side wall, and a second side wall.

4. The floor mat of claim 3, wherein the collapsible storage container further includes a bottom wall.

5. The floor mat of claim 3, wherein the first side wall and the second side wall each include a plurality of collapsible portions.

6. The floor mat of claim 1, wherein the collapsible storage container further includes at least one divider for subdividing the storage area into a plurality of smaller storage areas.

7. The floor mat of claim 6, wherein the at least one divider is selectively positionably adjustable to vary the sizes of the plurality of smaller storage areas.

8. The floor mat of claim 1, wherein the collapsible storage container is releasably connected to the main body.

9. The floor mat of claim 1, wherein the collapsible storage container further includes a lid that is positionable to cover the storage area.

10. The floor mat of claim 1, wherein the collapsible storage container includes an insulated portion that substantially maintains a temperature within the storage area.

11. The floor mat of claim 1, wherein at least a portion of the collapsible container is formed of a liquid resistant material.

12. The floor mat of claim 1, wherein a fabric lining is provided on at least one surface of the floor mat that is outwardly facing when the collapsible storage container is in the collapsed position.

13. The floor mat of claim 1, wherein an outer periphery of the main body includes a trimmable portion that may be selectively trimmed by a user to alter the outer periphery.

14. The floor mat of claim 1, wherein the floor mat is configured to overlie a floor in at least one of a cargo region of the vehicle or a passenger region of the vehicle.

15. A floor mat for use in a vehicle, the floor mat comprising:
a main body;
a first collapsible storage container operatively coupled with the main body and including at least one wall, the first collapsible storage container being selectively movable between a collapsed position in which the at least one wall lies substantially parallel to the main body and an erected position in which the at least one wall projects outwardly from the main body to define a first storage area; and
at least one second collapsible storage container operatively coupled with the main body and including at least one wall, the at least one second collapsible storage container being selectively movable between a collapsed position in which the at least one wall lies substantially parallel to the main body and an erected position in which the at least one wall projects outwardly from the main body to define a second storage area independent from the first storage area.

16. The floor mat of claim 15, wherein the main body includes a cavity sized and shaped to receive at least one of the first collapsible storage container or the at least one second collapsible storage container therein when the at least one of the first collapsible storage container or the at least one second collapsible storage container is in the collapsed position.

17. The floor mat of claim 15, wherein the first storage area defines a first volume and the at least one second storage area defines a second volume different than the first volume.

18. The floor mat of claim 15, wherein at least one of the first collapsible storage container or the at least one second collapsible storage container further includes a lid that is positionable to cover the corresponding at least one of the first storage area or the second storage area.

19. The floor mat of claim 15, wherein at least one of the first collapsible storage container or the at least one second collapsible storage container includes an insulated portion that substantially maintains a temperature within the corresponding at least one of the first storage area or the second storage area.

20. The floor mat of claim 15, wherein the main body includes a first portion, a second portion, and a medial portion connecting the first portion to the second portion, the first portion supporting the first collapsible storage container and the second portion supporting the second collapsible storage container.

21. The floor mat of claim 20, wherein the medial portion is formed with a width that is narrower than a width of the first portion and a width of the second portion.

22. A method of storing articles in a vehicle using a floor mat, the floor mat including a main body and a collapsible storage container operatively coupled with the main body and having at least one wall, the method comprising:
lifting an edge of the at least one wall to move the collapsible storage container from a collapsed position toward an erected position;
releasably locking the collapsible storage container in the erected position so that the at least one wall projects outwardly from the main body and defines a storage area.
